(19) United States
(12) Patent Application Publication
(10) Pub. No.: US 2009/0062438 A1
(43) Pub. Date: Mar. 5, 2009

(54) COPOLYESTERCARBONATE COMPOSITIONS

(76) Inventors: Robert Dirk van de Grampel, Het Lint (NL); Theodorus Lambertus Hoeks, Halsterseweg (NL); Jan-Pleun Lens, Kanatiestraat (NL); Dake Shen, Shanghai (CN); Rajendra Kashinath Singh, Evansville, IN (US)

Correspondence Address: SABIC - LEXAN;SABIC Innovative Plastics - IP Legal, ONE PLASTICS AVE., PITTSFIELD, MA, 01201-3697, US

(21) Appl. No.: 11/847,707

(22) Filed: Aug. 30, 2007

(51) Int. Cl. C08G 63/60; C08K 5/09; C08K 5/36

(52) U.S. Cl. 524/158; 524/267; 524/320; 524/599

(57) ABSTRACT

A fire-resistant copolyestercarbonate composition is provided comprising a salt-based flame retardant; and a copolyestercarbonate comprising a polycarbonate unit and a polyester unit, the polyester unit derived from the reaction of isophthalic acid, terephthalic acid, and resorcinol, the copolyestercarbonate containing from about 10 mole percent to 99.9 mole percent of the polyester unit. The composition also has improved scratch resistance and may be transparent.

### BACKGROUND

The present disclosure relates to fire-resistant copolyestercarbonate compositions, including transparent, fire-resistant copolyestercarbonate compositions and those having high scratch resistance. Also disclosed herein are methods for preparing and/or using the same.

Polycarbonates are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution.

Polycarbonates have many properties and/or characteristics that are desired in certain instances. These include clarity or transparency (i.e. 90% light transmission or more), high impact strength, heat resistance, weather and ozone resistance, good ductility, good electrical resistance, noncorrosive, nontoxic, etc. Furthermore, polycarbonates can be readily used in various article formation processes, such as molding (injection molding, etc.), extrusion, and thermoforming, among others. As a result, polycarbonates are used frequently to form a wide variety of products including: molded products, solution-cast or extruded films, structural parts, tubes and piping, lenses, safety shields, instrument windows, and medical devices. Household articles formed from polycarbonates can be produced in a great variety of colors and can be painted, glued, planed, pressed, and metalized and can be used to form precision parts and electronic products.

However, polycarbonate resins are inherently flammable. They can also drip hot molten material, causing nearby materials to catch fire as well. It is thus typically necessary to include fire retardant additives that retard the flammability of the polycarbonate resin and/or reduce dripping. Known additives include various sulfonic acid salts, phosphates, and halogenated flame retardants. However, phosphates generally need to be used at higher concentrations (5-10%) to achieve the same performance as sulfonic acid salts. Halogenated flame retardants, on the other hand, may release toxic or corrosive gases when heated to elevated temperatures.

Polycarbonate resins also lack scratch resistance. A secondary step, such as painting or coating a layer on top of the polycarbonate resin, is needed to obtain a glossy, scratch-resistant surface. This secondary step increases the amount of material used to produce a final product, lengthens production time, adds painting or coating steps, and decreases production yield. All of these increase the production cost.

There is a continued need for transparent polycarbonates which have improved scratch resistance, are fire resistant, and maintain other properties of polycarbonates.

### BRIEF DESCRIPTION

Disclosed, in various embodiments, are copolyestercarbonates and processes for making and using the same. The copolyestercarbonates have improved scratch resistance, are transparent, and can attain UL94 V0 ratings at 1.0 millimeter thickness.

In embodiments, a fire-resistant copolyestercarbonate composition is disclosed comprising: a salt-based flame retardant; and a copolyestercarbonate comprising a polycarbonate unit and a polyester unit, the polyester unit derived from the reaction of isophthalic acid, terephthalic acid, and a resorcinol moiety, the copolyestercarbonate having the general Formula (IV):

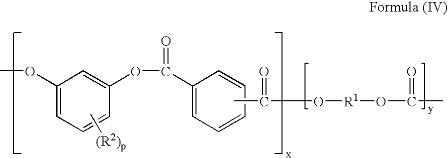

wherein x is the molar percentage of the polyester unit and y is the molar percentage of the polycarbonate unit, x and y adding up to 100 mole percent of the copolyestercarbonate; at least 56% of the total number of R¹ groups are aromatic organic radicals and the balance thereof are aliphatic, alicyclic, or aromatic radicals; each R² is independently selected from C₁₋₁₂ alkyl or halogen; and p is an integer from zero to 3; wherein the copolyestercarbonate contains from about 50 mole percent to 99.9 mole percent of the polyester unit; and wherein an article molded from the composition can attain UL94 V0 performance at a thickness of 2.0 millimeters.

In some embodiments, the copolyestercarbonate may contain from about 56 to about 90 mole percent of the polyester unit, or about 83 mole percent of the polyester unit.

In some embodiments, the composition may have a haze level of 6.0 or less, as measured by ASTM D1003 at 3.2 mm thickness. The composition may have a percent transmittance of 80 or higher, as measured by ASTM D1003 at 3.2 mm thickness.

In some embodiments, the composition further comprises a siloxane which may be present in the amount of greater than zero to about 0.6 parts per hundred parts resin (phr). The siloxane may be octaphenylcyclotetrasiloxane or a mixture of poly(methylphenyl siloxane) and octaphenylcyclotetrasiloxane. In some embodiments, the composition can attain UL94 V0 performance at a thickness of 1.5 millimeters or at 1.0 millimeters.

The salt-based flame retardant may be a perfluorobutane sulfonated salt. The salt-based flame retardant may be present in the amount of greater than zero to about 0.5 parts per hundred parts resin (phr). The flame retardant may be a K, Na, or Li salt. In other embodiments, the salt-based flame retardant is present in the amount of from about 0.06 to about 0.4 phr, and in more specific embodiments, from 0.2 to 0.3 phr. In some embodiments, the salt-based flame retardant is present in the amount of about 0.06 to about 0.26 phr

The composition may have a melt flow rate of from about 5 cc/10 minutes to about 25 cc/10 minutes, according to ASTM D1238. An article molded from the composition may have a pencil hardness of at least F, according to ASTM D3363.

The composition may contain no more than about 0.1 phr pentaerythritol tetrastearate.

R¹ may have the general formula:

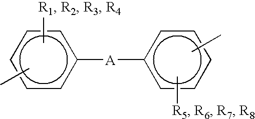

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In other embodiments, a fire-resistant copolyestercarbonate composition is disclosed comprising: octaphenylcyclotetrasiloxane; a sulfonated salt flame retardant; and a copolyestercarbonate comprising a polycarbonate unit and a polyester unit, the polyester unit derived from the reaction of isophthalic acid, terephthalic acid, and a resorcinol moiety, the copolyestercarbonate having the general Formula (IV):

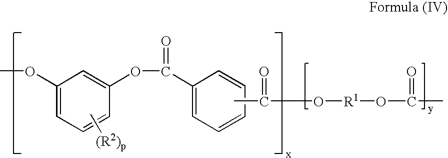

wherein x is the molar percentage of the polyester unit and y is the molar percentage of the polycarbonate unit, x and y adding up to 100 mole percent of the copolyestercarbonate; at least 56% of the total number of R¹ groups are aromatic organic radicals and the balance thereof are aliphatic, alicyclic, or aromatic radicals; each R² is independently selected from C₁₋₁₂ alkyl or halogen; and p is an integer from zero to 3; wherein the copolyestercarbonate contains from about 50 mole percent to 99.9 mole percent of the polyester unit; wherein an article molded from the composition can attain UL94 V0 performance at a thickness of 2.0 millimeters and has a haze level of 6.0 or less at a thickness of 3.2 mm, as measured by ASTM D1003; and an article molded from the composition has a pencil hardness of at least F, according to ASTM D3363.

In other embodiments, a fire-resistant copolyestercarbonate composition is disclosed comprising: octaphenylcyclotetrasiloxane; a salt-based flame retardant; and a copolyestercarbonate comprising a polycarbonate unit and a polyester unit, the polyester unit derived from the reaction of isophthalic acid, terephthalic acid, and a resorcinol moiety, the copolyestercarbonate having the general Formula (IV):

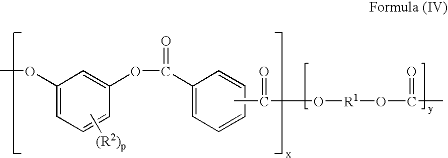

wherein x is the molar percentage of the polyester unit and y is the molar percentage of the polycarbonate unit, x and y adding up to 100 mole percent of the copolyestercarbonate; at least 56% of the total number of R¹ groups are aromatic organic radicals and the balance thereof are aliphatic, alicyclic, or aromatic radicals; each R² is independently selected from C₁₋₁₂ alkyl or halogen; and p is an integer from zero to 3; wherein the copolyestercarbonate contains from about 56 mole percent to about 90 mole percent of the polyester unit; and wherein an article molded from the composition can attain UL94 V0 performance at a thickness of 1.0 millimeters.

These and other non-limiting characteristics are more particularly described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 is a picture comparing chips containing poly alpha olefin for haze.

FIG. 2 is a picture comparing chips containing poly(methylphenyl siloxane) for haze.

### DETAILED DESCRIPTION

A more complete understanding of the components, processes and apparatuses disclosed herein can be obtained by reference to the accompanying drawings. These drawings are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

As used herein, “polycarbonate” refers to an oligomer or polymer comprising residues of one or more dihydroxy compounds joined by carbonate linkages.

The term “copolyestercarbonate” refers to a copolymer formed from a polycarbonate unit and a polyester unit.

The fire-resistant composition comprises a copolyestercarbonate, the copolyestercarbonate comprising a polycarbonate unit and a polyester unit. The polycarbonate unit may be a repeating structural carbonate unit of the formula (1):

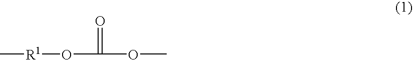

in which at least 56 percent of the total number of R¹ groups are aromatic organic radicals and the balance thereof are aliphatic, alicyclic, or aromatic radicals. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)

HO-A¹-Y¹-A²-OH (3)

wherein Y¹, A¹ and A² are as described above.

In specific embodiments, the dihydroxy compound has the structure of Formula (I):

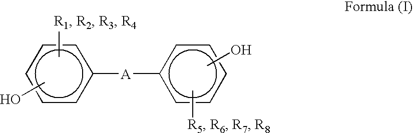

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl) propane (i.e. bisphenol-A or BPA). Other illustrative compounds of Formula (I) include:
2,2-bis(3-bromo-4-hydroxyphenyl)propane;
2,2-bis(4-hydroxy-3-methylphenyl)propane;
2,2-bis(4-hydroxy-3-isopropylphenyl)propane;
2,2-bis(3-t-butyl-4-hydroxyphenyl)propane;
2,2-bis(3-phenyl-4-hydroxyphenyl)propane;
2,2-bis(3,5-dichloro-4-hydroxyphenyl)propane;
1,1-bis(4-hydroxyphenyl)cyclohexane;
1,1-bis(3-chloro-4-hydroxyphenyl)-3,3,5-trimethylcyclohexane;
4,4′-dihydroxy-1,1′-biphenyl;
4,4′-dihydroxy-3,3′-dimethyl-1,1′-biphenyl;
4,4′-dihydroxy-3,3′-dioctyl-1,1′-biphenyl;
4,4′-dihydroxydiphenylether;
4,4′-dihydroxydiphenylthioether; and
1,3-bis(2-(4-hydroxyphenyl)-2-propyl)benzene.

The polyester unit is derived from the reaction of isophthalic acid, terephthalic acid, and a resorcinol moiety (also known as an ITR unit). The polyester unit has the general structure of Formula (II):

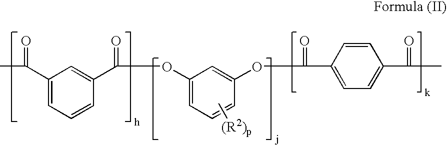

where h corresponds to the molar percentage of the isophthalate, j corresponds to the molar percentage of the resorcinol, and k corresponds to the molar percentage of the terephthalate; h, j, and k add up to 100 mole percent of the polyester unit; each R² is independently selected from C₁₋₁₂ alkyl or halogen; and p is an integer from zero to 3. “Alkyl” should be construed as including straight alkyl, branched alkyl, cycloalkyl, and aryl-substituted alkyl (such as benzyl). In some embodiments, the ratio of isophthalate to terephthalate (h:k) is from about 0.2 to about 4.0. In further embodiments, the ratio h:k is from about 0.4 to about 2.5 or from about 0.67 to about 1.5.

The polyester unit may also be represented by the general structure of Formula (III):

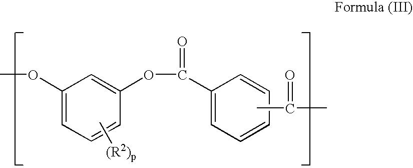

The copolyestercarbonate may be represented by the general structure of Formula (IV):

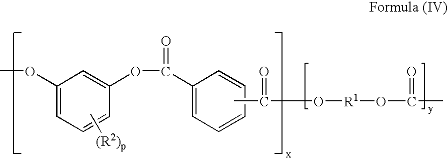

where x is the molar percentage of the polyester unit and y is the molar percentage of the polycarbonate unit, x and y adding up to 100 mole percent of the copolyestercarbonate; and R¹, R², and p are as defined above with respect to Formulas (1) and (II). Such copolyestercarbonates are available from General Electric Company with various molar ratios of polyester units to polycarbonate units, or x:y. Generally, the scratch resistance of the copolyestercarbonate increases as the polyester content increases.

In particular embodiments, the copolyestercarbonate contains from about 50 to 99.9 mole percent of the polyester unit. In other words, the ratio of x:y can be from about 50:50 to about 99.9:0.1. The copolyestercarbonate may also contain from about 56 to about 90 mole percent of the polyester unit. In specific embodiments, the copolyestercarbonate contains about 83 mole percent of the polyester unit.

In embodiments, the polyester units are substantially free of anhydride linkages. “Substantially free of anhydride linkages” means that the copolyestercarbonate shows a decrease in molecular weight of less than 10% upon heating said copolyestercarbonate at a temperature of about 280° C. to 290° C. for five minutes. In more particular embodiments, the copolyestercarbonate shows a decrease of molecular weight of less than 5%.

In various embodiments of Formula IV, the polyester units have a degree of polymerization (DP) of at least 30. In further embodiments, the polyester units have a DP of at least 50, at least 100, and in other embodiments from about 30 to about 150. The DP of the polycarbonate units is at least 1. In further embodiments, the polycarbonate units have a DP of at least 3, at least 10, and in other embodiments from about 20 to about 200. Within the context of the present disclosure, the architecture of the polyester and polycarbonate units may vary within the polycarbonate.

The fire-resistant composition may further comprise a siloxane. In embodiments, the siloxane is a phenyl-containing siloxane which increases flame retardant properties. As the number of phenyl groups in a siloxane increases, properties such as lubricity, oxidation resistance, thermal stability, and shear resistance increase as well. In specific embodiments, the phenyl-containing siloxane is selected from the group consisting of poly(methylphenyl siloxane) and octaphenylcyclotetrasiloxane. These two siloxanes are illustrated below:

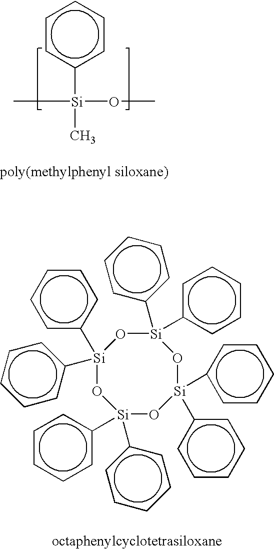

In other specific embodiments, a mixture of both poly(methylphenyl siloxane) and octaphenylcyclotetrasiloxane is used as the siloxane.

The siloxane may be present in the fire-resistant composition in the amount of greater than zero to about 0.6 parts per hundred parts resin (phr). Poly(methylphenyl siloxane) may generally be used in amounts of about 0.3 phr. Octaphenylcyclotetrasiloxane may generally be used in amounts of about 0.1 phr.

The fire-resistant composition further comprises a salt-based flame retardant. The flame retardant may be a K, Na, or Li salt. Useful salt-based flame retardants include alkali metal or alkaline earth metal salts of inorganic protonic acids and organic Bronstëd acids comprising at least one carbon atom. These salts should not contain chlorine and/or bromine. Preferably. the salt-based flame retardants are sulfonates. In specific embodiments, the salt-based flame retardant is from the group consisting of potassium diphenylsulfon-3-sulfonate (KSS), potassium perfluorobutane sulfonate (Rimar salt), and combinations comprising at least one of the foregoing.

The salt-based flame retardant(s) are present in quantities effective to achieve a UL94 V0 flame resistant rating. In general, the salt-based flame retardant is present in the amount of greater than zero to about 0.5 parts per hundred parts resin.

The fire-resistant composition may include various additives ordinarily incorporated in resin compositions of this type. Such additives include, for example, fillers or reinforcing agents; heat stabilizers; antioxidants; light stabilizers; plasticizers; antistatic agents; and blowing agents. Examples of fillers or reinforcing agents include glass fibers, glass beads, carbon fibers, silica, talc and calcium carbonate. Examples of heat stabilizers include triphenyl phosphite, tris-(2,6-dimethylphenyl)phosphite, tris-(2,4-di-t-butyl-phenyl) phosphite, tris-(mixed mono- and di-nonylphenyl)phosphite, dimethylbenzene phosphonate and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of light stabilizers include 2-(2-hydroxy-5-methylphenyl)benzotriazole, 2-(2-hydroxy-5-tert-octylphenyl)-benzotriazole and 2-hydroxy-4-n-octoxy benzophenone. Examples of plasticizers include dioctyl-4,5-epoxy-hexahydrophthalate, tris-(octoxycarbonylethyl)isocyanurate, tristearin and epoxidized soybean oil. Examples of the antistatic agent include glycerol monostearate, sodium stearyl sulfonate, and sodium dodecylbenzenesulfonate. Examples of mold releasing agents include pentaerythritol tetrastearate, stearyl stearate, beeswax, montan wax and paraffin wax. Examples of other resins include but are not limited to polypropylene, polystyrene, polymethyl methacrylate, and polyphenylene oxide.

Colorants may be added if desired. These include pigments, dyes, and quantum dots. The amount may vary and generally is low enough that the composition maintains its transparency.

UV absorbers may be used. Exemplary UV absorbers include hydroxybenzophenones; hydroxybenzotriazoles; hydroxybenzotriazines; cyanoacrylates; oxanilides; benzoxazinones; nano-size inorganic materials such as titanium oxide, cerium oxide, and zinc oxide, all with particle size less than 100 nanometers; or the like, or combinations comprising at least one of the foregoing UV absorbers.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like.

Anti-drip agents may be included. Anti-drip agents may be, for example, a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A useful TSAN may comprise, for example, 50 wt % PTFE and 50 wt % SAN, based on the total weight of the encapsulated fluoropolymer. The SAN may comprise, for example, 75 wt % styrene and 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer.

Combinations of any of the foregoing additives may be used. Such additives may be mixed at a suitable time during the mixing of the components for forming the composition.

Mold release agents generally make the processing of the copolyestercarbonate easier. However, it has been found that the type of mold release agent used affects the clarity of the copolyestercarbonate. For example, a commonly used mold release agent in polycarbonates is pentaerythritol tetrastearate (PETS). However, when used in a copolyestercarbonate, PETS causes high initial haze in the copolyestercarbonate. Thus, in embodiments, pentaerythritol tetrastearate (PETS) is not present in the fire-resistant copolyestercarbonate composition at levels above 0.1 phr.

The fire-resistant copolyestercarbonate composition may be made by intimately mixing the copolyestercarbonate, siloxane, and salt-based flame retardant either in solution or in melt, using any known mixing method. Typically, there are two distinct mixing steps: a premixing step and a melt mixing step. In the premixing step, the ingredients are mixed together. This premixing step is typically performed using a tumbler mixer or a ribbon blender. However, if desired, the premix may be manufactured using a high shear mixer such as a Henschel mixer or similar high intensity device. The premixing step must be followed by a melt mixing step where the premix is melted and mixed again as a melt. Alternatively, it is possible to eliminate the premixing step, and simply add the raw materials directly into the feed section of a melt mixing device (such as an extruder) via separate feed systems. In the melt mixing step, the ingredients are typically melt kneaded in a single screw or twin screw extruder, and extruded as pellets. U.S. patent application Ser. No. 11/276,026 also describes methods of preparing copolyestercarbonate compositions.

The resulting fire-resistant copolyestercarbonate composition has several desirable properties. The composition is transparent. In embodiments, the composition may have a haze level of 6.0 or less, as measured by ASTM D1003 at 3.2 mm thickness. It may have a percent transmittance greater than or equal to 80, as measured by ASTM D1003 at 3.2 mm thickness. It may have a melt volume rate (MVR) of from about 5 to about 25 cc/10 minutes, according to ASTM D1238. Generally, the lower the MVR, the greater the fire retardance. The composition may have a pencil hardness of at least F, according to ASTM D3363.

In particular embodiments, the fire-resistant copolyestercarbonate composition can attain UL94 V0 performance at a thickness of 2.0 millimeters, has a haze level of 6.0 or less as measured by ASTM D1003 at 3.2 mm thickness, and a article molded from the composition has a pencil hardness of at least F according to ASTM D3363.

It was surprisingly found that as the ITR content of the copolyestercarbonate increased, so did the fire resistance of the final composition. Copolyestercarbonates having ITR polyester units are known to have good weathering properties, such as being resistant to photodegradation and attack by solvents. However, these properties generally do not relate to flame retardance capability. The literature on copolyestercarbonates based on bisphenol-A did not suggest any improvement in fire retardance capability over polycarbonates either. In addition, Rimar salt is widely used as a fire retardant additive, but polycarbonates usually turn opaque (i.e. not transparent) as the Rimar salt loading increases. However, copolyestercarbonates containing ITR polyester units surprisingly maintained their transparency and fire resistance properties for long periods of time, even at Rimar salt loadings as high as 0.26 phr, at gauges as low as 1.0 millimeters. Commercial grades of transparent fire-resistant polycarbonates can achieve V0 performance at 1.5 millimeter thickness, but not 1.0 millimeter thickness. Achieving a polycarbonate that combined the properties of transparency at high Rimar loadings and V0 performance at gauges lower than commercially available was unexpected.

The following examples are provided to illustrate the compositions and methods of the present disclosure. The examples are merely illustrative and are not intended to limit devices made in accordance with the disclosure to the materials, conditions, or process parameters set forth therein.

### EXAMPLES

### Example 1

A copolyestercarbonate designated ITR9010 had about 82.5 mole % polyester units. The ITR9010 resin was prepared in the following manner. Other ITR resins were prepared in similar manners.

Oligomer Synthesis:

To a 200 gallon (750 L) glass lined reactor equipped with condenser, agitator, pH probe, caustic inlet, and recirculation loops were added methylene chloride (281 L), triethylamine (0.74 kg, 7.31 mol), an aqueous solution of resorcinol (89 kg solution, 44.9% w/w, 362 mol), and a methylene chloride solution of p-cumylphenol (10.8 kg, 33% w/w, 16.7 mol, adjustable to achieve a desired MVR target). A molten mixture of isophthaloyl chloride and terephthaloyl chloride isomers (DAC, 1:1 molar ratio of isomers, 66.3 kg, 326 mol, 4.3 kg/min) was added to the reaction vessel while simultaneously adding sodium hydroxide (50% w/w sodium hydroxide solution, 0.7 NaOH/DAC weight ratio or 1.77 NaOH/DAC molar ratio) as a separate stream over a 15 min period. The pH decreased from pH 7-8 to pH ˜4. After completion of DAC addition, sodium hydroxide was added to raise the pH to 7-8.5. The reactor contents were stirred for 10 min.

Phosgenation:

To a 300 gal (1,125 L) glass-lined reactor equipped with condenser, agitator, pH probe, phosgene inlet, caustic inlet, and recirculation loop were charged bisphenol-A (6.5 kg, 28.2 mol), sodium gluconate (0.16 kg), water (132 L) and methylene chloride (154 L). The entire oligomer solution from the oligomer reactor was transferred to the phosgenation reactor by rinsing the oligomer reactor and its condensers with 22.5 L of methylene chloride. Phosgene (18 kg total, 183.4 mol) was co-fed with sodium hydroxide (50% w/w) to the reactor under ratio-pH control. The phosgene addition rate was maintained at 91 kg/hr for the initial 80% of phosgene addition (14.5 kg) and decreased to 68 kg/hr for the remaining 20% of phosgene addition (3.6 kg). The sodium hydroxide/phosgene ratio profile of the batch started with a NaOH/phosgene weight ratio of 2.30 which was changed to 2.20 at 10% of phosgene addition, 2.00 at 50% of phosgene addition, and 2.50 at 70% of phosgene addition. The targeted pH for the phosgenation reaction was ˜8 for the initial 70% of phosgenation and 8.5 for the remaining 30% of phosgenation. The batch was sampled for molecular weight analyses and then re-phosgenated (4.5 kg phosgene, 45.9 mol, pH target 9.0). The pH was raised to about 9 with 50% w/w sodium hydroxide and the batch was transferred to a centrifuge feed tank, where hydrochloric acid was added to lower the pH of the batch to pH ˜8. The resultant solution of polymer in methylene chloride was purified by acid wash and subsequent water washes via centrifugation. The final polymer was isolated by steam precipitation and dried under a stream of hot nitrogen.

### Example 2

Flammability tests were performed following the procedure of Underwriter's Laboratory Bulletin 94 entitled “Tests for Flammability of Plastic Materials, UL94”, which is incorporated herein by reference. According to this procedure, the materials were classified as either UL94 V0, UL94 V1 or UL94 V2 on the basis of the test results obtained for five samples. The procedure and criteria for each of these flammability classifications according to UL94, are, briefly, as follows:

Procedure: A total of 10 specimens (2 sets of 5) are tested per thickness. Five of each thickness are tested after conditioning for 48 hours at 23° C., 50% relative humidity. The other five of each thickness are tested after conditioning for seven days at 70° C. The bar is mounted with the long axis vertical for flammability testing. The specimen is supported such that its lower end is 9.5 mm above the Bunsen burner tube. A blue 19 mm high flame is applied to the center of the lower edge of the specimen for 10 seconds. The time until the flaming of the bar ceases is recorded. If burning ceases, the flame is re-applied for an additional 10 seconds. Again, the time until the flaming of the bar ceases is recorded. If the specimen drips particles, these shall be allowed to fall onto a layer of untreated surgical cotton placed 305 mm below the specimen.

Criteria for flammability classifications according to UL94:

| | V0 | V1 | V2 |
|---|---|---|---|
| Individual flame time (sec) | ≦10 | ≦30 | ≦30 |
| Total flame time of 5 specimens (sec) | ≦50 | ≦250 | ≦250 |
| Glowing time of individual specimens (sec) | ≦30 | ≦60 | ≦60 |
| Particles ignite cotton? | No | No | Yes |

Light transmission and haze values were measured using color plaques of 3.2 mm thickness for the compositions of Example 1.

The melt volume rate (MVR) was measured according to ASTM D1238 at 300° C., 1.2 kg.

Table 1 shows the results of the UL94 test for the bars tested after conditioning for 48 hours at 23° C., 50% relative humidity for the given thickness for a control composition C1 and four exemplary compositions E1-E4. Each composition was made using the materials listed in Table 1. The amounts listed are parts per hundred parts resin. The ingredients were pre-blended, then extruded and molded under normal processing conditions.

The low flow PC was a low flow Bisphenol-A polycarbonate homopolymer with a target molecular weight of 29,900 (based on GPC using polycarbonate standards). The high flow PC was a high flow Bisphenol-A polycarbonate homopolymer with a target molecular weight of 21,900 (based on GPC using polycarbonate standards). Stabilizer 1 was cycloaliphatic epoxy resin and Stabilizer 2 was phosphonous acid ester (PEPQ powder). The siloxane used was octaphenylcyclotetrasiloxane. The ITR resins were copolyestercarbonates containing the molar amount of ITR units shown in the “amount of ITR” row.

The FOT 5 value referred to the flame out time for 5 specimens. The drops value referred to the number of specimens that dripped.

TABLE 1

| Description | Unit | C1 | E1 | E2 | E3 | E4 |
|---|---|---|---|---|---|---|
| Low flow PC | phr | 80 | | | | |
| High flow PC | phr | 20 | | | | |
| ITR2080 resin | phr | | 100 | | | |
| ITR4060 resin | phr | | | 100 | | |
| ITR6040 resin | phr | | | | 100 | |
| ITR9010 resin | phr | | | | | 100 |
| PETS | phr | 0.3 | 0.3 | 0.3 | 0.3 | |
| poly(methylphenyl | phr | | | | | 0.3 |
| siloxane) | | | | | | |
| Stabilizer 1 | phr | 0.03 | 0.03 | 0.03 | 0.03 | 0.03 |
| Stabilizer 2 | phr | 0.06 | 0.06 | 0.06 | 0.06 | 0.06 |
| Rimar | phr | 0.08 | 0.08 | 0.08 | 0.08 | 0.08 |
| octaphenylcyclo | phr | 0.1 | 0.1 | 0.1 | 0.1 | 0.1 |
| tetrasiloxane | | | | | | |
| amount of ITR | mol % | 0 | 19 | 42 | 56 | 82.5 |
| MVR | cc/10 min | 9.2 | 11.8 | 8.11 | 7.44 | 10.6 |
| % Light Transmission | % | 90.9 | 89.3 | 88.9 | 87.6 | 86 |
| Haze | % | 0.8 | 1.1 | 1.6 | 1.8 | 1.4 |
| V0 @3.0 mm (23° C., 48 hr) | FOT 5 (s) | 30.6 | 31.55 | | | |
| V0 @3.0 mm (23° C., 48 hr) | drops | 0/10 | 0/10 | | | |
| V0 @3.0 mm (23° C., 48 hr) | pass/fail | pass | pass | | | |
| V0 @2.5 mm (23° C., 48 hr) | FOT 5 (s) | 56.5 | 40.75 | 32.75 | | |
| V0 @2.5 mm (23° C., 48 hr) | drops | 10/10 | 07/10 | 0/10 | | |
| V0 @2.5 mm (23° C., 48 hr) | pass/fail | fail | fail | pass | | |
| V0 @2.0 mm (23° C., 48 hr) | FOT 5 (s) | | | 32.3 | 20.6 | |
| V0 @2.0 mm (23° C., 48 hr) | drops | | | 07/10 | 0/10 | |
| V0 @2.0 mm (23° C., 48 hr) | pass/fail | | | fail | pass | |
| V0 @1.8 mm (23° C., 48 hr) | FOT 5 (s) | | | | 26.3 | 18.4 |
| V0 @1.8 mm (23° C., 48 hr) | drops | | | | 10/10 | 0/10 |
| V0 @1.8 mm (23° C., 48 hr) | pass/fail | | | | fail | pass |
| V0 @1.5 mm (23° C., 48 hr) | FOT 5 (s) | | | | | 15.85 |
| V0 @1.5 mm (23° C., 48 hr) | drops | | | | | 0/10 |
| V0 @1.5 mm (23° C., 48 hr) | pass/fail | | | | | pass |

The control C1, which contained no copolyestercarbonate, could only attain V0 performance at a thickness of 3.0 mm. The amount of ITR in the copolyestercarbonate was also important in determining the performance. As seen in E1 and E2, the ITR resin containing 42 mole % ITR units could only attain V0 performance at a thickness of 2.5 mm. E3 and E4, on the other hand, which contained 56 mole % and 82.5 mole % ITR units respectively, could affain V0 performance at 2.0 mm and at a thickness as low as 1.5 mm.

Table 2 shows how fire resistance varied as the amount of siloxane was varied. Three controls C5-C7 and three exemplary compositions E5-E7 were made using the materials listed. PETS was used as a mold release agent. Compositions E5-E7 each contained 82.5 mole % ITR units. The UL94 tests were done at 2.0 mm thickness at the environmental conditions listed.

TABLE 2

| Description | Unit | C5 | C6 | C7 | E5 | E6 | E7 |
|---|---|---|---|---|---|---|---|
| Low flow PC | phr | 50 | 50 | 50 | | | |
| High flow PC | phr | 50 | 50 | 50 | | | |
| ITR9010 resin | phr | | | | 100 | 100 | 100 |
| Stabilizer 1 | phr | 0.03 | 0.03 | 0.03 | 0.03 | 0.03 | 0.03 |
| Stabilizer 2 | phr | 0.06 | 0.06 | 0.06 | 0.06 | 0.06 | 0.06 |
| PETS | phr | 0.1 | 0.1 | 0.1 | 0.1 | 0.1 | 0.1 |
| Rimar | phr | 0.08 | 0.08 | 0.08 | 0.08 | 0.08 | 0.08 |
| octaphenylcyclo | phr | 0.1 | 0.05 | 0 | 0.1 | 0.05 | 0 |
| tetrasiloxane | | | | | | | |
| MVR | cc/10 min | 13.1 | 14.2 | 13.1 | 12.0 | 11.9 | 12.3 |
| V0@2.0 mm | FOT 5 (s) | 42.9 | 45.6 | 43.1 | 28 | 23.1 | 26.2 |
| (23° C., 48 hr) | | | | | | | |
| V0@2.0 mm | Drops | 02/10 | 02/10 | 0/10 | 0/10 | 0/10 | 0/10 |
| (23° C., 48 hr) | | | | | | | |
| V0@2.0 mm | pass/fail | fail | fail | pass | pass | pass | pass |
| (23° C., 48 hr) | | | | | | | |
| V0@2.0 mm | FOT 5 (s) | 43 | 44.5 | 41.3 | 22.6 | 20.3 | 22.5 |
| (70° C., 168 hr) | | | | | | | |
| V0@2.0 mm | Drops | 03/10 | 03/10 | 03/10 | 0/10 | 0/10 | 0/10 |
| (70° C., 168 hr) | | | | | | | |
| V0@2.0 mm | pass/fail | fail | fail | fail | pass | pass | pass |
| (70° C., 168 hr) | | | | | | | |

The results show that higher amounts of ITR units provided additional fire resistance to the composition as all of the exemplary compositions (E5-E7) achieved UL94 V0 performance at 2.0 mm at both conditions.

Table 3 shows how fire resistance varied with different amounts of Rimar salt and different mold release agents. The two mold release agents were PETS and poly(methylphenyl siloxane). The V0 results are given for the bars tested after conditioning for 48 hours at 23° C., 50% relative humidity.

TABLE 3

| Description | Unit | C8 | E8 | E9 | E10 | E11 | E12 | E13 |
|---|---|---|---|---|---|---|---|---|
| ITR9010 resin | phr | 100 | 100 | 100 | 100 | 100 | 100 | 100 |
| Stabilizer 1 | phr | 0.03 | 0.03 | 0.03 | 0.03 | 0.03 | 0.03 | 0.03 |
| Stabilizer 2 | phr | 0.06 | 0.06 | 0.06 | 0.06 | 0.06 | 0.06 | 0.06 |
| PETS | phr | 0.1 | | | | | | |
| poly(methylphenyl | phr | | 0.1 | 0.1 | 0.1 | 0.1 | 0.1 | 0.1 |
| siloxane) | | | | | | | | |
| Rimar | phr | 0.08 | 0.08 | 0.06 | 0.04 | 0.04 | 0.02 | 0.01 |
| octaphenylcyclo | phr | 0.1 | 0.1 | 0.1 | 0.1 | 0.1 | 0.1 | 0.1 |
| tetrasiloxane | | | | | | | | |
| MVR | cc/10 min | 11.3 | 12.3 | 12.4 | 12.2 | 11.4 | 11.6 | 11.8 |
| V0 @1.5 mm | FOT 5 (s) | 22.5 | 27.3 | 24.4 | 26.3 | 21.2 | 22.7 | 34.1 |
| (23° C., 48 hr) | | | | | | | | |
| V0 @1.5 mm | drops | 04/10 | 0/10 | 0/10 | 0/10 | 05/10 | 08/10 | 07/10 |
| (23° C., 48 hr) | | | | | | | | |
| V0 @1.5 mm | pass/fail | fail | pass | pass | pass | fail | fail | fail |
| (23° C., 48 hr) | | | | | | | | |

Comparing C8 to E8 showed that poly(methylphenyl siloxane) contributed to improved fire resistance (i.e. achieving UL94 V0 at 1.5 mm), whereas PETS did not. E12 and E13 showed that 0.02 parts of Rimar salt was too low to impart fire resistance to the copolyestercarbonate at 1.5 mm thickness. E10 and E11 had identical compositions, but very different performance. This indicated that at 0.04 phr Rimar salt, the composition was at the boundary level for attaining V0 performance at 1.5 mm thickness.

Table 4 shows how fire resistance varied with higher amounts of Rimar salt. Four controls C14-C17 and seven exemplary compositions E14-E20 were prepared using the materials listed. Compositions E14-E20 contained 82.5 mole % ITR units, whereas the controls C14-C17 contained no ITR units. The V0 results are given for both sets of bars at 1.0 mm thickness. Haze was measured at 3.2 mm thickness.

TABLE 4

| Description | Unit | C14 | C15 | C16 | C17 |
|---|---|---|---|---|---|
| Low flow PC | phr | 50 | 50 | 50 | 50 |
| High flow PC | phr | 50 | 50 | 50 | 50 |
| ITR9010 resin | phr | | | | |
| Stabilizer 1 | phr | 0.03 | 0.03 | 0.03 | 0.03 |
| Stabilizer 2 | phr | 0.06 | 0.06 | 0.06 | 0.06 |
| poly(methylphenyl | phr | 0.3 | 0.3 | 0.3 | 0.3 |
| siloxane) | | | | | |
| Rimar | phr | 0.08 | 0.14 | 0.2 | 0.26 |
| octaphenylcyclo | phr | 0.1 | 0.1 | 0.1 | 0.1 |
| tetrasiloxane | | | | | |
| MVR | cc/10 min | 12.2 | 12.2 | 12.2 | 12.2 |
| % Light | % | 89.6 | 78.4 | 63.3 | 54.2 |
| Transmission | | | | | |
| Haze | % | 1.1 | 29.7 | 74.8 | 90.8 |
| V0 @1.0 mm | FOT 5 (s) | 14.3 | 40.5 | 11.2 | 16.4 |
| (23° C., 48 hr) | | | | | |
| V0 @1.0 mm | drops | 02/10 | 02/10 | 0/10 | 0/10 |
| (23° C., 48 hr) | | | | | |
| V0 @1.0 mm | pass/fail | fail | fail | pass | pass |
| (23° C., 48 hr) | | | | | |
| V0 @1.0 mm | FOT 5 (s) | 39.9 | 54.6 | 45.1 | 36.6 |
| (70° C., 168 hr) | | | | | |
| V0 @1.0 mm | drops | 09/10 | 09/10 | 10/10 | 10/10 |
| (70° C., 168 hr) | | | | | |
| V0 @1.0 mm | pass/fail | fail | fail | fail | fail |
| (70° C., 168 hr) | | | | | |

| Description | Unit | E14 | E15 | E16 | E17 | E18 | E19 | E20 |
|---|---|---|---|---|---|---|---|---|
| Low flow PC | phr | | | | | | | |
| High flow PC | phr | | | | | | | |
| ITR9010 resin | phr | 100 | 100 | 100 | 100 | 100 | 100 | 100 |
| Stabilizer 1 | phr | 0.03 | 0.03 | 0.03 | 0.03 | 0.03 | 0.03 | 0.03 |
| Stabilizer 2 | phr | 0.06 | 0.06 | 0.06 | 0.06 | 0.06 | 0.06 | 0.06 |
| poly(methylphenyl | phr | 0.3 | 0.3 | 0.3 | 0.3 | 0.3 | 0.3 | 0.3 |
| siloxane) | | | | | | | | |
| Rimar | phr | 0.08 | 0.14 | 0.2 | 0.26 | 0.3 | 0.4 | 0.5 |
| octaphenylcyclo | phr | 0.1 | 0.1 | 0.1 | 0.1 | 0.1 | 0.1 | 0.1 |
| tetrasiloxane | | | | | | | | |
| MVR | cc/10 min | 10.6 | 11.8 | 13.1 | 11.8 | 14 | 13.8 | 14.1 |
| % Light | % | 86 | 83.7 | 84.9 | 83.2 | 83 | 66.8 | 50.7 |
| Transmission | | | | | | | | |
| Haze | % | 1.4 | 2.7 | 2.4 | 3.5 | 5.4 | 25.1 | 81.7 |
| V0 @1.0 mm | FOT 5 (s) | 20.7 | 22.2 | 19.6 | 15 | 14.7 | 16.2 | 12.3 |
| (23° C., 48 hr) | | | | | | | | |
| V0 @1.0 mm | drops | 10/10 | 03/10 | 02/10 | 0/10 | 0/10 | 0/10 | 0/10 |
| (23° C., 48 hr) | | | | | | | | |
| V0 @1.0 mm | pass/fail | fail | fail | fail | pass | pass | pass | pass |
| (23° C., 48 hr) | | | | | | | | |
| V0 @1.0 mm | FOT 5 (s) | 19.2 | 22.7 | 22.8 | 30.2 | 14.2 | 13.6 | 11.9 |
| (70° C., 168 hr) | | | | | | | | |
| V0 @1.0 mm | drops | 9/10 | 02/10 | 0/10 | 0/10 | 0/10 | 0/10 | 0/10 |
| (70° C., 168 hr) | | | | | | | | |
| V0 @1.0 mm | pass/fail | fail | fail | pass | pass | pass | pass | pass |
| (70° C., 168 hr) | | | | | | | | |

The results show that the presence of the ITR unit imparts fire resistance to the copolyestercarbonate at equivalent loadings of Rimar salt. Comparing E16 and E17, however, the Rimar salt level must be at least 0.26 phr to attain fire resistance at 1.0 mm thickness. E19 and E20 suggest that a Rimar salt loading of less than 0.4 phr is necessary to prevent the copolyestercarbonate from having too high an initial haze at 3.2 mm thickness (i.e. the copolyestercarbonate is not transparent). In addition, compared to the controls C14-C17, E17-E19 have less haze (i.e., are more transparent). E17-E19 also surprisingly have V0 performance at 1.0 mm and maintain it for the longer time period (see the 70° C., 168 hr results).

### Example 3

Two compositions E21-E22 were made to test the effects of the mold release agents PETS on the initial haze. Stabilizer 1 was cycloaliphatic epoxy resin and Stabilizer 2 was phosphonous acid ester (PEPQ powder). The compositions were made into plaques of 3.2 mm thickness and tested according to ASTM D1003. Table 5 shows the results.

TABLE 5

| Description | Unit | E21 | E22 |
|---|---|---|---|
| ITR9010 resin | phr | 100 | 100 |
| PETS | phr | | 0.3 |
| Stabilizer 1 | phr | 0.03 | 0.03 |
| Stabilizer 2 | phr | 0.09 | 0.09 |
| Rimar | phr | 0.08 | 0.08 |
| octaphenylcyclotetrasiloxane | phr | 0.1 | 0.1 |
| Haze | % | 1.4 | 15.6 |

The results showed that PETS at an amount of 0.3 phr caused unacceptable initial high haze at 3.2 mm thickness.

Next, two compositions E23-E24 were made to test the effect of two mold release agents on the initial haze. The polymethylphenylsiloxane was TSF437 from GE Toshiba Silicones. Table 6 shows the results.

TABLE 6

| Description | Unit | E23 | E24 |
|---|---|---|---|
| ITR9010 resin | phr | 100 | 100 |
| poly(methylphenylsiloxane) | phr | 0.3 | |
| poly alpha olefin (PAO) | phr | | 0.3 |
| Stabilizer 2 | phr | 0.06 | 0.06 |
| pigment 1 | phr | 0.0001 | 0.0001 |
| pigment 2 | phr | 0.003 | 0.003 |
| MVR | cc/10 min | 10.9 | 11.7 |
| Haze | % | 1.4 | 1.5 |

The results showed that both poly(methylphenyl siloxane) and PAO gave acceptable initial haze.

To determine whether the initial low haze would remain, or whether haze might occur due to phase separation, chips were made with 0.3% poly(methylphenyl siloxane), PAO in varying amounts (0.1% 0.15%, and 0.2%), and a control chip was made having no mold release agent. The chips were dried overnight at 125° C. The chips were then annealed at 170° C. for one hour, then cooled down.

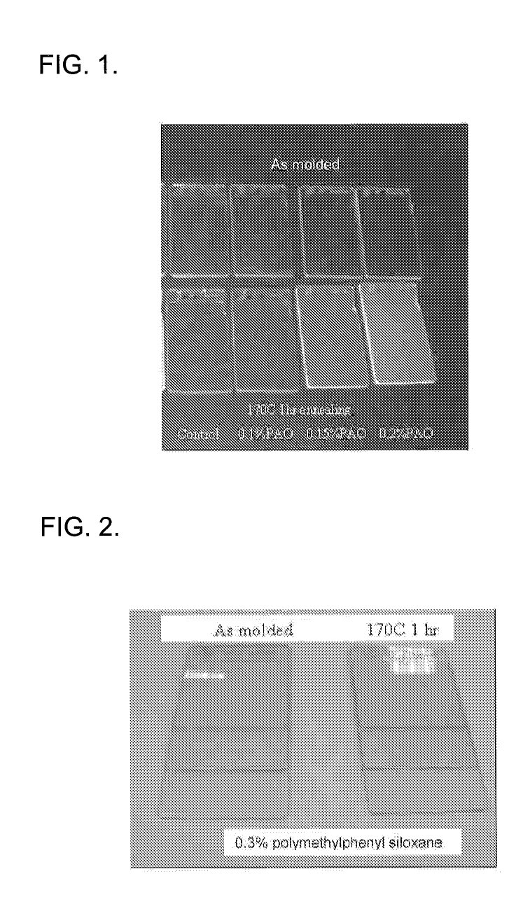

FIG. 1 shows the control chip and PAO chips prior to annealing and after annealing. FIG. 2 shows the control chip and poly(methylphenyl siloxane) chip prior to annealing and after annealing. Comparing FIG. 1 with FIG. 2, the PAO chips showed an unacceptable haze after annealing, whereas the poly(methylphenyl siloxane) chip remained transparent after annealing.

The UL94 test was performed on a control C25 and three exemplary compositions E25-E27. The control C25 used polycarbonate homopolymers, whereas E25-27 used an ITR resin. The mold release agent varied among E25-27.

Mechanical properties were measured according to the following ASTM standards:

| | Standards | Testing Conditions | Specimen Type |
|---|---|---|---|
| Melt Volume | ASTM D 1238 | 300° C., 1.2 Kg | |
| Rate | | | |
| Haze | ASTM D1003 | 23° C. | 3.2 mm thickness |
| Transmission | ASTM D1003 | 23° C. | 3.2 mm thickness |
| Scratch Testing | ASTM D3363 | | |

Melt Volume Rate was measured by ASTM D1238. A charge of material was placed in a vertical cylinder with a small die of 2 mm at the bottom and heated at the specified temperature. A specified load was then placed on the molten material and material extruded through the die was collected. The amount of material extruded after a given time was then normalized to cc/10 min.

Haze and transmission were measured according to ASTM D1003. A specimen of a specified thickness was placed in the path of a narrow beam of light so that some of the light passes through the specimen and some of the light continues unimpeded. Both parts of the beam pass into a sphere equipped with a photo detector. The haze and transmission can then be calculated based on the strength of the light beam and the amount of light deviating from the original beam.

Scratch Testing was measured using the Pencil Hardness Test ASTM D3363. Pencil hardness is a standard method to test scratch resistance. Pencil lead comes in varying degrees of hardness. A soft lead leaves a heavy dark line while a hard lead leaves a finer gray line. The standard hardness of pencils is measured as 6H, 5H, 4H, 3H, 2H, H, F, HB, B, 2B, 3B, 4B, 5B, and 6B, with 6H being the hardest and 6B being the softest. When the pencil lead is drawn across the surface of a sample, a soft lead may not scratch the sample while a hard lead may. Samples can then be rated by the hardness of the pencil lead that will scratch the surface.

The results are shown in Table 7.

TABLE 7

| Description | Unit | C18 | E25 | E26 | E27 |
|---|---|---|---|---|---|
| Low flow PC | phr | 80 | | | |
| High flow PC | phr | 20 | | | |
| ITR9010 resin | phr | | 100 | 100 | 100 |
| PETS | phr | 0.3 | | | |
| PAO | phr | | | 0.3 | |
| Poly(methylphenyl | phr | | | | 0.3 |
| siloxane) | | | | | |
| Stabilizer 1 | phr | 0.03 | 0.03 | 0.03 | 0.03 |
| Stabilizer 2 | phr | 0.06 | 0.09 | 0.09 | 0.09 |
| Rimar | phr | 0.08 | 0.08 | 0.08 | 0.08 |
| octaphenylcyclo | phr | 0.1 | 0.1 | 0.1 | 0.1 |
| tetrasiloxane | | | | | |
| MVR | cc/10 min | 9.2 | 10.4 | 10.5 | 10.6 |
| Transmission | % | 90.9 | 84.7 | 84.1 | 85.0 |
| V0 @ 1.8 mm (23° C., | FOT (s) | 28.3 | 19.5 | 22.9 | 18.5 |
| 48 hr) | | | | | |
| V0 @ 1.8 mm (23° C., | drops | 10/10 | 2/10 | 1/10 | 0/10 |
| 48 hr) | | | | | |
| V0 @ 1.8 mm (23° C., | Pass/fail | fail | fail | fail | pass |
| 48 hr) | | | | | |
| Pencil hardness | | 2B | F | F | F |

The presence of the ITR resin imparted scratch resistance to E25-E27 compared to the control C18. Only E27, which used poly(methylphenyl siloxane), passed the UL94 V0 test at 1.8 mm. E27 also had F pencil hardness, compared to 2B hardness for C18, and had acceptable light transmission.

The copolyestercarbonates of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A fire-resistant copolyestercarbonate composition comprising:
a salt-based flame retardant; and
a copolyestercarbonate comprising a polycarbonate unit and a polyester unit, the polyester unit derived from the reaction of isophthalic acid, terephthalic acid, and a resorcinol moiety, the copolyestercarbonate having the general Formula (IV): 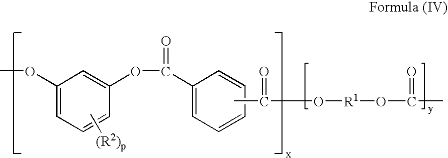
wherein x is the molar percentage of the polyester unit and y is the molar percentage of the polycarbonate unit, x and y adding up to 100 mole percent of the copolyestercarbonate; at least 56% of the total number of R¹ groups are aromatic organic radicals and the balance thereof are aliphatic, alicyclic, or aromatic radicals; each R² is independently selected from C₁₋₁₂ alkyl or halogen; and p is an integer from zero to 3;
wherein the copolyestercarbonate contains from about 50 mole percent to 99.9 mole percent of the polyester unit; and
wherein an article molded from the composition can attain UL94 V0 performance at a thickness of 2.0 millimeters.

2. The composition of claim 1, wherein the polyestercarbonate contains from about 56 to about 90 mole percent of the polyester unit.

3. The composition of claim 1, wherein a molded sample of the composition has a haze level of 6.0 or less at 3.2 mm thickness, as measured by ASTM D1003.

4. The composition of claim 1, wherein a molded sample of the composition has a percent transmittance of 80 or higher at 3.2 mm thickness, as measured by ASTM D1003.

5. The composition of claim 1, further comprising a siloxane present in the amount of greater than zero to about 0.6 parts per hundred parts resin.

6. The composition of claim 5, wherein the siloxane is octaphenylcyclotetrasiloxane.

7. The composition of claim 6, wherein an article molded from the composition can attain UL94 V0 performance at a thickness of 1.5 millimeters.

8. The composition of claim 6, wherein an article molded from the composition can attain UL94 V0 performance at a thickness of 1.0 millimeters.

9. The composition of claim 5, wherein the siloxane is a mixture of poly(methylphenyl siloxane) and octaphenylcyclotetrasiloxane.

10. The composition of claim 1, wherein the salt-based flame retardant is a perfluorobutane sulfonated salt.

11. The composition of claim 1, wherein the salt-based flame retardant is present in the amount of greater than zero to about 0.5 parts per hundred parts resin.

12. The composition of claim 1, wherein the composition has a melt volume rate of from about 5 cc/10 minutes to about 25 cc/10 minutes, according to ASTM D1238.

13. The composition of claim 1, wherein an article molded from the composition has a pencil hardness of at least F, according to ASTM D3363.

14. The composition of claim 1, containing no more than 0.1 parts per hundred parts resin of pentaerythritol tetrastearate.

15. The composition of claim 1, wherein R¹ has the general formula: 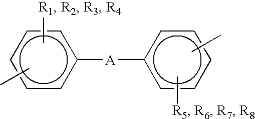
wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

16. A fire-resistant copolyestercarbonate composition comprising:
octaphenylcyclotetrasiloxane;
a sulfonated salt flame retardant; and
a copolyestercarbonate comprising a polycarbonate unit and a polyester unit, the polyester unit derived from the reaction of isophthalic acid, terephthalic acid, and a resorcinol moiety, the copolyestercarbonate having the general Formula (IV): 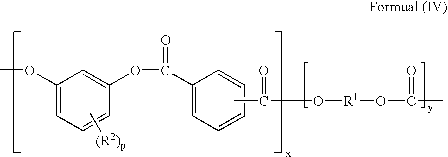
wherein x is the molar percentage of the polyester unit and y is the molar percentage of the polycarbonate unit, x and y adding up to 100 mole percent of the copolyestercarbonate; at least 56% of the total number of R¹ groups are aromatic organic radicals and the balance thereof are aliphatic, alicyclic, or aromatic radicals; each R² is independently selected from C₁₋₁₂ alkyl or halogen; and p is an integer from zero to 3;
wherein the copolyestercarbonate contains from about 50 mole percent to 99.9 mole percent of the polyester unit;
wherein an article molded from the composition can attain UL94 V0 performance at a thickness of 2.0 millimeters and has a haze level of 6.0 or less at a thickness of 3.2 mm, as measured by ASTM D1003; and
an article molded from the composition has a pencil hardness of at least F, according to ASTM D3363.

17. The composition of claim 16, wherein the copolyestercarbonate contains from about 56 to about 90 mole percent of the polyester unit.

18. The composition of claim 16, wherein the sulfonated salt flame retardant is a perfluorobutane sulfonate.

19. The composition of claim 16, wherein the octaphenylcyclotetrasiloxane is present in the amount of greater than zero to about 0.6 parts per hundred parts resin.

20. A fire-resistant copolyestercarbonate composition comprising:
octaphenylcyclotetrasiloxane;
a salt-based flame retardant; and
a copolyestercarbonate comprising a polycarbonate unit and a polyester unit, the polyester unit derived from the reaction of isophthalic acid, terephthalic acid, and a resorcinol moiety, the copolyestercarbonate having the general Formula (IV): 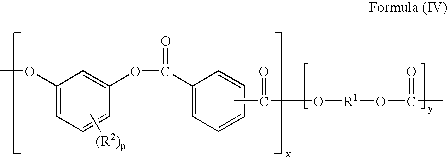
wherein x is the molar percentage of the polyester unit and y is the molar percentage of the polycarbonate unit, x and y adding up to 100 mole percent of the copolyestercarbonate; at least 56% of the total number of R¹ groups are aromatic organic radicals and the balance thereof are aliphatic, alicyclic, or aromatic radicals; each R² is independently selected from C₁₋₁₂ alkyl or halogen; and p is an integer from zero to 3;
wherein the copolyestercarbonate contains from about 56 mole percent to about 90 mole percent of the polyester unit; and
wherein an article molded from the composition can attain UL94 V0 performance at a thickness of 1.0 millimeters.

21. The composition of claim 20, wherein an article molded from the composition has a pencil hardness of at least F, according to ASTM D3363.

22. The composition of claim 20, wherein the composition further comprises poly(methylphenyl siloxane).

23. The composition of claim 20, wherein the polyestercarbonate contains about 83 mole percent of the polyester unit.

24. The composition of claim 20, wherein a molded sample of the composition has a haze level of 6.0 or less at 3.2 mm thickness, as measured by ASTM D1003.
